(19) United States
(12) Patent Application Publication
(10) Pub. No.: US 2025/0278321 A1
(43) Pub. Date: Sep. 4, 2025

(54) HARDWARE-AGNOSTIC REST ENDPOINTS FOR ASYNCHRONOUS OPERATIONS

(71) Applicant: Hewlett Packard Enterprise Development LP, Spring, TX (US)

(72) Inventor: Derek Lee Fults, Orlando, FL (US)

(21) Appl. No.: 18/591,924

(22) Filed: Feb. 29, 2024

(51) Int. Cl. G06F 9/54; G06F 16/955; H04L 67/02

(52) U.S. Cl. CPC G06F 9/547; G06F 9/541; G06F 16/955; H04L 67/02

(57) ABSTRACT

A system receives a request, via a representational state transfer (REST) application programming interface (API). The request includes: a search term for hostnames; a starting universal resource identifier (URI) associated with the hostnames; and a flag indicating use of members corresponding to the hostnames. The system obtains the hostnames by searching a database based on the search term. The system generates Hypertext Transfer Protocol (HTTP) requests based on the starting URI, the obtained hostnames, and members corresponding to a respective obtained hostname. The system transmits the generated HTTP requests asynchronously to endpoints based on the REST API and receives data from the endpoints in response to the first request indicating a GET command.

### BACKGROUND

### Field

Representational State Transfer (REST) application programming interfaces (APIs) can be used to issue Hypertext Transfer Protocol (HTTP) requests to endpoints or hosts for transferring data over the HTTP protocol. Multiple REST endpoints may include specific target hardware, individual Universal Resource Identifiers (URIs), and specific data to be collected, which can require advanced knowledge of each vendor's specific configuration in order to extract or execute the desired information.

### BRIEF DESCRIPTION OF THE FIGURES

FIG. 1 illustrates an environment which facilitates hardware-agnostic REST endpoints for asynchronous operations, in accordance with an aspect of the present application.

FIG. 2 illustrates a diagram of communications which facilitate hardware-agnostic REST endpoints for asynchronous operations, in accordance with an aspect of the present application.

FIG. 3A presents a table depicting an exemplary mapping of hardware types to vendor URIs, in accordance with an aspect of the present application.

FIG. 3B presents a table depicting exemplary lists of members with corresponding URIs, in accordance with an aspect of the present application.

FIG. 3C presents a diagram depicting pseudocode for a single REST API request (including a traversal of the members) and the corresponding response data, in accordance with an aspect of the present application.

FIG. 4A presents a diagram depicting pseudocode for a single REST API request (including a search key and a traversal of the members) and the corresponding response data, in accordance with an aspect of the present application.

FIG. 4B presents a diagram depicting pseudocode for a single REST API request (including a search key and a traversal of the members) and the corresponding response data, in accordance with an aspect of the present application.

FIG. 5A presents a diagram depicting pseudocode for a single REST API request (including a search key, a traversal of the members, and a target action) and the corresponding request data, in accordance with an aspect of the present application.

FIG. 5B presents a diagram depicting pseudocode for a single REST API request (including a search key, a traversal of the members, and a target action) and the corresponding response data, in accordance with an aspect of the present application.

FIG. 6A presents a flowchart illustrating a method which facilitates hardware-agnostic REST endpoints for asynchronous operations, in accordance with an aspect of the present application.

FIG. 6B presents a flowchart illustrating a method which facilitates hardware-agnostic REST endpoints for asynchronous operations, in accordance with an aspect of the present application.

FIG. 7 illustrates a computer system which facilitates hardware-agnostic REST endpoints for asynchronous operations, in accordance with an aspect of the present application.

FIG. 8 illustrates a computer-readable medium which facilitates hardware-agnostic REST endpoints for asynchronous operations, in accordance with an aspect of the present application.

In the figures, like reference numerals refer to the same figure elements.

### DETAILED DESCRIPTION

Aspects of the instant application solve the problem of requiring prior knowledge of individual hardware types and vendors in order to communicate with target endpoints for HTTP requests by providing a single, configurable access point (e.g., a single REST API request) for generating multiple asynchronous HTTP requests. The single REST API request can use an expandable hostname search in conjunction with stored access credentials and include options which can be parsed and passed to either underlying APIs (e.g., based on Python) or to asynchronous APIs (e.g., based on Redfish). The options passed to the asynchronous APIs can include customizable options for traversal of members associated with hostnames, search filters, and target actions.

Currently, REST APIs are often used to issue HTTP requests to endpoints or hosts for transferring data over the HTTP protocol. One current method uses the client URL (“curl”) line command and requires issuing an HTTP request to each individual endpoint, including login credentials in each command, and using an exact universal resource identifier (URI), e.g.:
# curl-sk--user “root:initial0”-XGET
   https://x9000c1s0b0: 443/redfish/v1/Chassis/Node0.
      This curl line command specifies the credentials with an exact URI and can only be issued one at a time to a specific URI, which may be cumbersome.

Another current method loops through hosts and may require a synchronous and pre-assembled list of hostnames, e.g.:
# cat host.txt; ‘x9000c1s1b0 x9000c1s0b0’
# for i in ‘cat host.txt’; do curl-sk--user “root:initial0”-XGET
https://$i:443/redfish/v1/Chassis/Node0; done
   The above commands may only work if the list of hostnames is already known at the time the command is called, which may not always be feasible.

Yet another method using a Parallel Distributed Shell (PDSH) can provide hostname expansion and some login credential optimizations, but sub-processes each require their own command, e.g.:
# pdsh-w x9000c1s[0,1]b0 curl-sk--user “root:initial0”-XGET
https://% h:443/redfish/v1/Chassis/Node0
   However, sub-processes may each require their own command, creating one process per host, which can affect the performance.

Furthermore, multiple REST endpoints may include specific target hardware, individual vendor URIs (e.g., Redfish URIs), and specific data to be collected, which can require advanced knowledge of each vendor's specific configuration in order to extract or execute the desired information. Such advance and specific knowledge for each vendor may not always be possible and may also result in inefficient and cumbersome methods to transfer data.

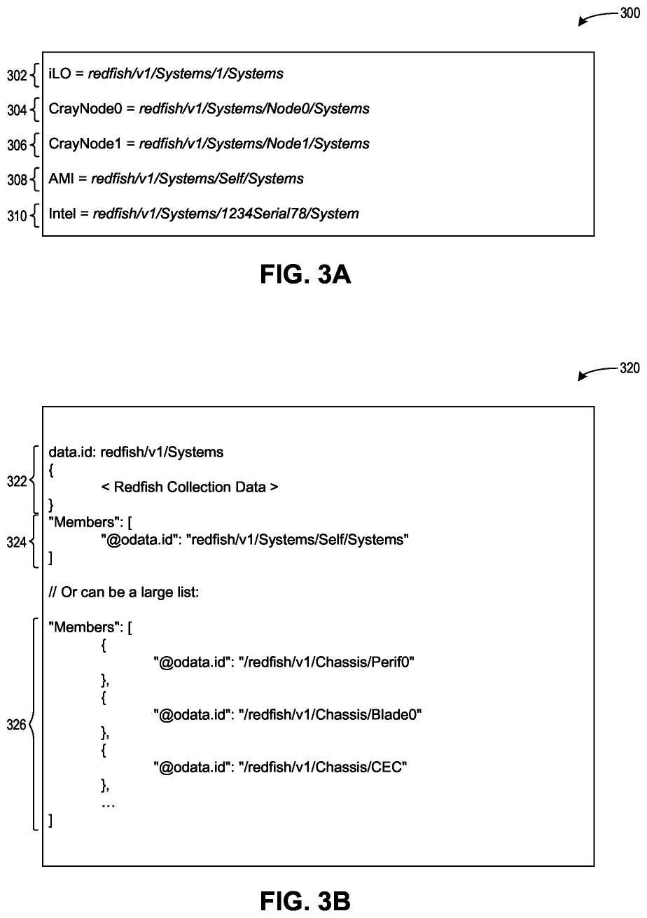

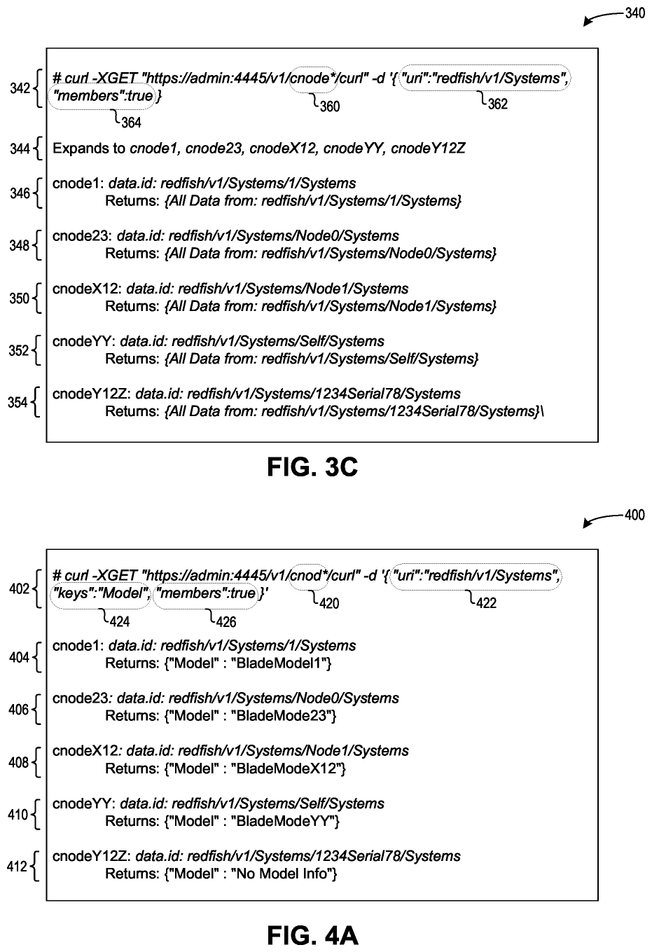

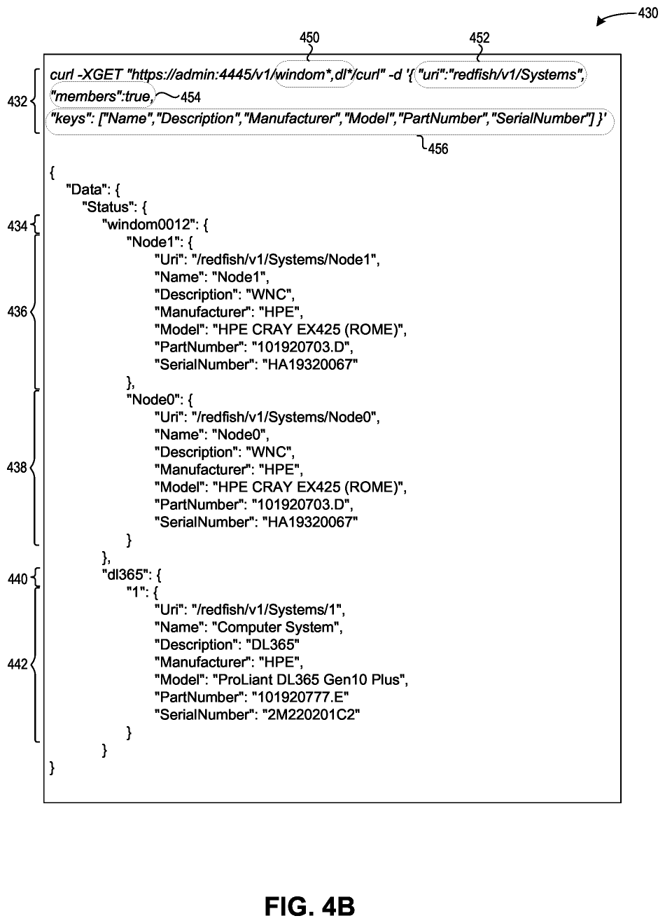

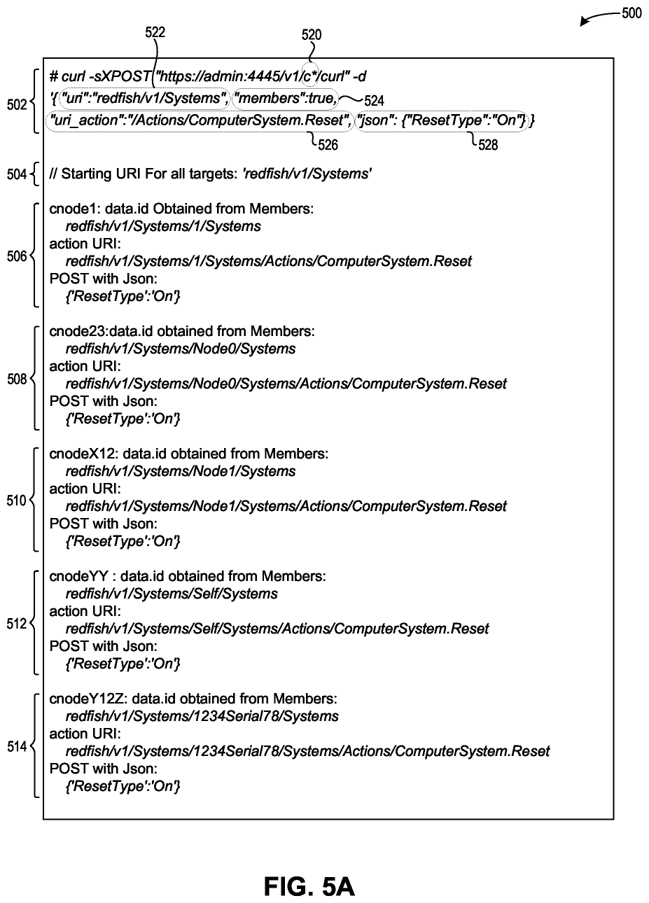

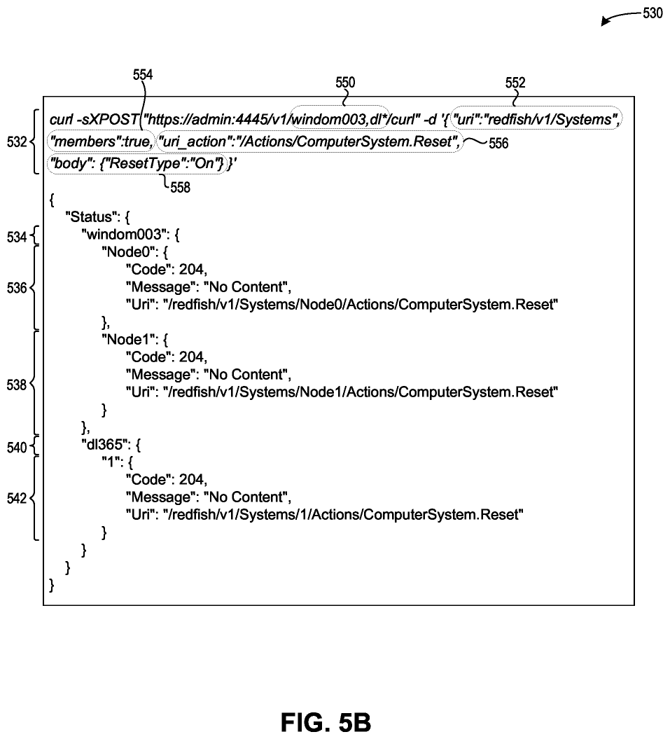

Aspects of the instant application provide a system which can take as input a single REST API request and generate as output multiple HTTP requests which can be sent asynchronously to multiple REST endpoints. The REST API request can include an expandable hostname and a starting URI associated with the hostnames. The system can search, in a database, for access credentials corresponding to the expanded hostnames. The REST API request can also include various options which can be parsed and passed to underlying Python APIs or to Redfish asynchronous APIs. The options passed to the Redfish asynchronous APIs can include customizable options or flags for traversal of members associated with hostnames (“members,” as described below in relation to FIG. 3C), search filters (“keys,” as described below in relation to FIGS. 4A and 4B), and target actions with configured parameter settings (“actions,” as described below in relation to FIGS. 5A and 5B). The system can generate the HTTP requests based on the starting URI, the URIs and access credentials for expanded hostnames obtained from the database search, and the parsed options.

The REST API request can provide a single, configurable access point which can include pre-existing options for underlying Python APIs or customizable options for Redfish asynchronous APIs. The customizable options can be input as a JavaScript Object Notation (JSON) body, as described below in relation to FIGS. 5A and 5B. By providing the single access point with the customizable options to generate multiple asynchronous HTTP requests, the described aspects can overcome the limitations and challenges of the current methods and provide a more efficient and less cumbersome method for communicating with endpoints or hosts using the REST API.

The term “Representational State Transfer” application programming interface (REST API) refers to a protocol used to communicate via HTTP requests in order to perform standard database functions, e.g., creating, reading, updating, and deleting records within a resource. A REST API request, call, or command can use any HTTP method to access the state of a resource and can use a variety of formats to return information. One common format is JavaScript Object Notation (JSON), which can be programming language-agnostic. In this disclosure, the term “data object” or “data body” can refer to structured data which can be represented by a data object standard, e.g., a text-based format. While examples of the described aspects in this disclosure may include JSON objects, other standards or formats for data objects may be used. Furthermore, the term “scripting software” can refer to software based on any scripting language, including but not limited to Python. A REST API request can also include parameters or options listed as key-value pairs, as described below in relation to FIGS. 3C, 4A, 4B, 5A, and 5B. In the described aspects, a single REST API request may generate multiple HTTP requests.

The terms “host” and “endpoint” are used interchangeably in this disclosure and refer to a device, component, or hardware component which can be identified by a URI. An HTTP request can obtain specified data from the URI and can also cause a specified target action to be performed on the host or endpoint identified by the URI. A host or endpoint can also be a network device which includes multiple ports or interfaces for uplinks and can communicate with other network devices.

The term “asynchronous API” refers to a module or interface which can send requests asynchronously to designated endpoints. For example, in the described aspects where a single REST API request generates multiple HTTP requests, each generated HTTP request may be sent to an individual host or endpoint based on a timing which is unrelated to the generation, transmission, or receipt of any other generated HTTP request. In some aspects, the asynchronous API can be associated with a protocol for management of components in a software-defined hybrid information technology (IT) network or other network environment, e.g., Redfish.

The term “hardware-agnostic” refers to not being tied to any specific hardware and not needing to specify the exact URI or identifier for a host or endpoint. An example of vendors that may provide hosts or endpoints can include Redfish vendors, in which case the term “hardware-agnostic” may also be referred to as

“Redfish implementation-agnostic.” The disclosed aspects facilitate hardware-agnostic REST endpoints by using a single, configurable REST API request

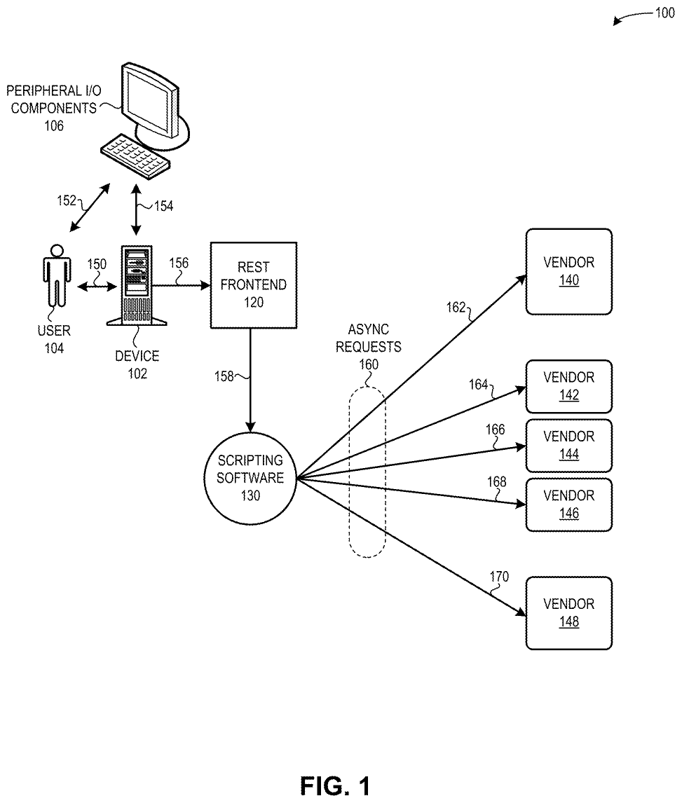

FIG. 1 illustrates an environment 100 which facilitates hardware-agnostic REST endpoints for asynchronous operations, in accordance with an aspect of the present application. Environment 100 can include a device 102 with an associated user 104 and associated peripheral input/output (I/O) components 106, e.g., a display, a keyboard, a mouse (not shown), etc. Device 102, user 104, and components 106 can communicate with each other via communications 150, 152, and 154. Device 102 can communicate with a REST frontend 120. For example, user 104 may type or enter a REST request or command into a command line interface (CLI) using peripheral I/O components 106, which can cause device 102 to send a REST request to REST frontend 120 (via a communication 156). The REST request can include options indicated as key-value pairs, as described below in relation to FIGS. 3C, 4A, 4B, 5A, and 5B.

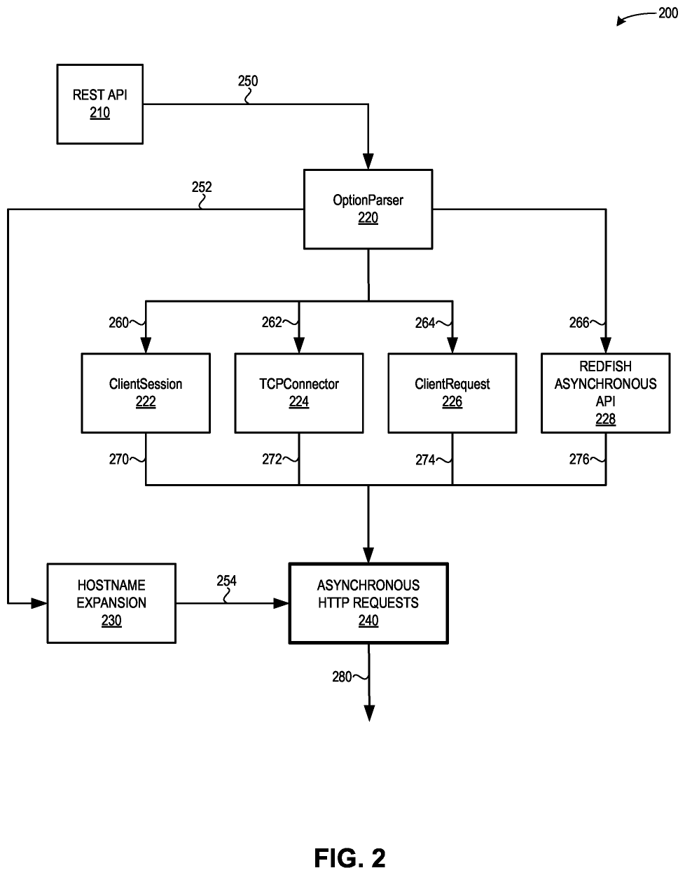

REST frontend 120 can send the REST request, including the options, to an underlying opensource technology or scripting software 130, such as Python (via a communication 158). Elements of scripting software 130 are described below in relation to FIG. 2. Scripting software 130 can parse the request and generate and send multiple asynchronous requests 160 to multiple REST endpoints or individual vendors, e.g.: an asynchronous request 162 can be sent to a vendor 140; an asynchronous request 164 can be sent to a vendor 142; an asynchronous request 166 can be sent to a vendor 144; an asynchronous request 168 can be sent to a vendor 146; and an asynchronous request 170 can be sent to a vendor 148. In some aspects, vendors 142, 144, and 146 may represent different hardware components of the same vendor. Asynchronous requests 160 can be HTTP requests, and scripting software 130 can asynchronously transmit the HTTP requests to the endpoints (vendors 140-148), e.g., using asynchronous input/output (“asyncio”) or asynchronous HTTP client/server for asyncio (“aiohttp”) functionality associated with Python.

FIG. 2 illustrates a diagram 200 of communications which facilitate hardware-agnostic REST endpoints for asynchronous operations, in accordance with an aspect of the present application. Diagram 200 can include: a REST API 210; an OptionParser 220 (such as a JSON OptionParser); multiple underlying classes, such as a ClientSession 222, a TCPConnector 224, and a ClientRequest 226; a Redfish asynchronous API 228; a hostname expansion 230 module; and generated asynchronous HTTP requests 240.

REST API 210 may receive or determine a REST request (e.g., via communication 156 in FIG. 1), which can include various elements or options. The REST request can include a search term for hostnames. REST API 210 can send (via a communication 250) the REST request to OptionParser 220, which can send the search term to hostname expansion 230 module (via a communication 252). Hostname expansion 230 can obtain a set of expanded hostnames by searching a database (not shown) using the search term. For example, in a cluster with a list of hostnames such as cnode01, cnode02, . . . , cnode99, cnid1, cnid2, . . . cnid10, the REST request may include a search term of “c*,” which would expand to all “cXXXX” (and “cXXXXX” and “cXXXXXX”) hostnames in the cluster, e.g.:
# curl-k-XGET “https://admin:4445/v1/node/c*/curl”-d
   ‘{“uri”:“redfish/v1/Chassis/Node0”}’
      Hostname expansion 230 can use a list of hostnames or any of {*, [], ?} to search for and determine the expanded hostnames, thus allowing for a full regular expression search pattern as opposed to using only bracketed numeric expansion.

In the example above, the endpoint has the name “curl” for illustrative purposes only, as the described aspects use the Python async aoihttp requests. During operation, a ClientSession can be started and the corresponding HTTP request can be issued for each of the hosts, which can be determined from the expanded hostnames. Login or access credentials to the Redfish interface may be unique and can be stored with the node information in the database. Thus, the system can look up the credentials (e.g., “username, password”) in the database and apply the credentials to the ClientSession for each host. Hostname expansion 230 can send (via a communication 254) each expanded hostname along with the host-specific access credentials to be used in generating asynchronous HTTP requests 240. An example of hostname expansion is provided below in relation to FIGS. 3A-C. A starting URI (and in some aspects, a partial URI associated with a target action) may be included in the REST request and obtained for use in generating asynchronous HTTP requests 240 via OptionParser 220.

The REST request can also include elements or options, including any of the Python aiohttp class options (e.g., 222, 224, 226) as well as new options for a Redfish asynchronous API (228).

The underlying aiohttp class options can include pre-existing ClientSession options, TCPConnector options, and ClientRequest options. The ClientSession 222 options can include ‘base_url’, ‘connector’, ‘loop’, ‘cookies’, ‘headers’, ‘skip_auto_headers’, ‘auth’, ‘json_serialize’, ‘request_class’, ‘response_class’, ‘ws_response_class’, ‘version’, ‘cookie_jar’, ‘connector_owner’, ‘raise_for_status’, ‘read_timeout’, ‘conn_timeout’, ‘timeout’, ‘auto_decompress’, ‘trust_env’, ‘requote_redirect_url’, ‘trace_configs’, and ‘read_bufsize’. The TCPConnector 224 options can include ‘verify_ssl’, ‘fingerprint’, ‘use_dns_cache’, ‘ttl_dns_cache’, ‘family’, ‘ssl_context’, ‘ssl’, ‘local_addr’, ‘resolver’, ‘keepalive_timeout’, ‘force_close’, ‘limit’, ‘limit_per_host’, and ‘enable_cleanup_closed’. The ClientRequest 226 options can include ‘method’, ‘url’, ‘params’, ‘data’, ‘json’, ‘headers’, ‘skip_auto_headers’, ‘auth’, ‘allow_redirects’, ‘max_redirects’, ‘compress’, ‘chunked’, ‘expect100’, ‘raise_for_status’, ‘read_until_eof’, ‘proxy’, ‘proxy_auth’, and ‘read_bufsize’.

The new options for the Redfish asynchronous API can include, e.g.: a flag indicating use of members corresponding to the hostnames; one or more search keys indicating one or more filters; a partial URI associated with a target action; and a JSON object with at least one parameter setting which can be applied to the target action.

Upon receiving or determining the REST request, REST API 210 may send (via communication 250) the REST request to OptionParser 220, which can determine how to parse or process the options include in the REST request. If the option corresponds to a key-value pair which indicates one of the underlying aiohttp class options, OptionParser 220 can send a respective option to the corresponding underlying aiohttp class. For example, if the option is {“headers”:XYZ}, OptionParser 220 can send this option (via a communication 260) to underlying ClientSession 222. ClientSession 222 can process and send this option (via a communication 270) to be used in generating asynchronous HTTP requests 240. Generated asynchronous HTTP requests 240 can be sent (via a communication 280) to the REST endpoint designated by a respective generated asynchronous HTTP request 240. Similarly, if the option is {“force_close”:true}, OptionParser 220 can send this option (via a communication 262) to underlying TCPConnector 224, and if the option is {“allow_redirects”:true}, OptionParser 220 can send this option (via a communication 264) to underlying ClientRequest 226. TCPConnector 224 and ClientRequest 226 can process and send their respective options (via, respectively, communications 272 and 274) to be used in generating asynchronous HTTP requests 240, which can be sent to the indicated REST endpoints.

In addition to using the underlying aiohttp class options, the described embodiments can use custom options or flags for the Redfish asynchronous API.

These options or flags can be used individually or in combination to achieve any REST operation across a cluster of multiple nodes or endpoints. The options can include: a traversal of members (using a key named “members” as described below in relation to FIG. 3C); a search key with one or more filters (using a key named “keys” as described below in relation to FIG. 4A); a partial URI associated with a target action; and a key indicating a JSON object with a parameter setting, which can be applied to the target action (using a key named “uri_action” as described below in relation to FIG. 5A).

For example, if the option is {“keys”:“Model”}, OptionParser 220 can send this option (via a communication 266) to the Redfish asynchronous API 228. Redfish asynchronous API 228 can process and send this option, along with the URI obtained from hostname expansion 230 via communication 254, to be combined as an asynchronous HTTP request 240. This generated asynchronous HTTP request 240 can be sent (via communication 280) to the REST endpoint designated by the generated asynchronous HTTP request 240.

Return or response data (not shown) received from a REST endpoint in response to a generated asynchronous HTTP request 240 can be encapsulated in a consistent JSON body (as described below in relation to FIGS. 4B and 5B).

Thus, by providing the customizable options (i.e., members, keys, action) to be configured in the single REST API request, the described aspects can provide more than an endpoint which collects data from selected controllers in a cluster. The described aspects provide a method to generate asynchronous HTTP requests using a single access point, including hostname expansion and access credentials lookup as well as the customizable actions for member traversal, search filters, and target actions with parameter settings. Specifically, the system can iterate through the expanded hostnames and generate the asynchronous HTTP requests using the starting URIs, target actions, and other JSON information, as described further in relation to FIGS. 3C, 4A, 4B, 5A, and 5B.

Identifiers of hardware or endpoints (e.g., Redfish data identifiers or “data.ids”) may not be consistent across various types of hardware. Current solutions may require mapping each hardware type to a specific vendor (e.g., a specific Redfish vendor) identifier for different operations.

FIG. 3A presents a table 300 depicting an exemplary mapping of hardware types to vendor URIs, in accordance with an aspect of the present application. Specific product names or paths in table 300 are provided as non-limiting illustrative examples. Table 300 can include: a mapping 302 of “iLO” to “/redfish/v1/Systems/1/Systems”; a mapping 304 of “CrayNode0” to “/redfish/v1/Systems/Node0/Systems”; a mapping 306 of “CrayNode1” to “/redfish/v1/Systems/Node1/Systems”; a mapping 308 of “AMI” to “/redfish/v1/Systems/Self/Systems”; and a mapping of “Intel” to “/redfish/v1/Systems/1234Serial78/Systems.” In order to gather data from an endpoint at “redfish/v1/Systems/<collection id>/Systems,” the system can use the mapping depicted in FIG. 3. However, using only the mapping in FIG. 3 can require a lookup for each host, and the lookup can subsequently be embedded in the specific host request.

The described embodiments can use the “members” property of a Resource Collection to communicate more efficiently with the endpoints. The members property can identify the members of the collection. For example, given a “starting URI” of “redfish/v1/Systems,” a corresponding members entry can include a list of URIs or “data.id”s which are contained with the top level of the starting URI.

FIG. 3B presents a table 320 depicting exemplary lists of members with corresponding URIs, in accordance with an aspect of the present application. Specific product names or paths in table 320 are provided as non-limiting illustrative examples. Section 322 can define the starting URI or data.id of “redfish/v1/Systems” as including certain “Redfish Collection Data” and section 324 can define the members with a data.id of “redfish/v1/Systems/Self/Systems.” Alternatively, section 326 can define the members as a large list, which includes members with: a data.id of “/redfish/v1/Chassis/Perif0”; a data.id of “redfish/v1/Chassis/Blade0”; and a data.id of “/redfish/v1/Chassis/CEC.”

FIG. 3C presents a diagram 340 depicting pseudocode for a single REST API request (including a traversal of the members) and the corresponding response data, in accordance with an aspect of the present application. Specific product names or paths in diagram 340 are provided as non-limiting illustrative examples. Diagram 340 can include pseudocode for an exemplary REST API request 342, listed as a “curl” command for illustration purposes only. Request 342 can indicate a “GET” command (“-XGET”) to retrieve or obtain data. “admin:4445” can indicate the server providing the endpoint and a search term 360 of “cnode*” can be used to obtain expanded hostnames. Search term 360 can include a wildcard character (e.g., “*”), and the system can search a database using the search term for a list of expanded hostnames, to obtain the associated credentials and the URI or data.id for each hostname. Request 342 can also include a starting URI 362 of {“uri”:“redfish/v1/Systems”} to which additional URI information for members (or actions, as described below in relation to FIGS. 5A and 5B) may be appended. Request 342 can further include a key-value pair or an option 364 of {“members”:true}, which can indicate that the members list is to be traversed to determine the data.id or URI for each expanded hostname. Option 364 can be a customizable option passed to and handled by the Redfish asynchronous API (228 of FIG. 2).

Thus, using the search term of “cnode*,” the hostname expansion (as in module 230 of FIG. 2) can return “cnode1, cnode23, cnodeX12, cnodeYY, cnodeY12Z.” A lookup in the database for each hostname and a traversal of the members list for the starting URI can return the data.id or URI for a respective hostname and member. The system can generate an asynchronous HTTP request based on the expanded hostname and the member list traversal. Because no filter or search options are included in the request 342, a generated and transmitted asynchronous HTTP request can return all the data from the designated endpoint. In diagram 340, each of sections 346, 348, 350, 352, and 354 indicates the hostname with the corresponding starting URI and data.id from the member traversal and further indicates that all the data from the designated endpoint is returned. For example, as shown in section 346, “cnode1” corresponds to a data.id of “redfish/v1/Systems/1/Systems,” and, based on request 342, the system can generate an asynchronous HTTP request that returns all the data from “redfish/v1/Systems/1/Systems.” By using the hostname expansion along with the starting URI and the member traversal, the described embodiments can remain agnostic to the actual hardware types of the endpoints. In this case, the single request 342 does not need to have knowledge of the hardware type or component “iLO” (depicted in mapping 302 of FIG. 3A) as corresponding to “redfish/v1/System/1/Systems.” Instead, the system can generate the asynchronous HTTP request by traversing the members list and using the fully expandable hostname along with access credentials, which can result in a more efficient and hardware-agnostic execution of asynchronous operations on REST endpoints.

The REST request can be optimized to simplify the response data by combining the members list with search keys and filters. Including search keys and filters in the request can allow a user to obtain specific information for any vendor or type of hardware. FIG. 4A presents a diagram 400 depicting pseudocode for a single REST API request (including a search key and a traversal of the members) and the corresponding response data, in accordance with an aspect of the present application. Specific product names, paths, or information in diagram 400 are provided as non-limiting illustrative examples. Diagram 400 can include pseudocode for an exemplary REST API request 402, listed as a “curl” command for illustration purposes only. Similar to request 342 of diagram 340, request 402 can indicate a “GET” command (“-XGET”) to retrieve or obtain data. “admin: 4445” can indicate the server providing the endpoint and a search term 420 of “cnod*” can be used to obtain expanded hostnames. Search term 420 can include a wildcard character (e.g., “*”), and the system can search a database using search term 420, for a list of expanded hostnames, to obtain the associated credentials and the URI or data.id for each hostname. Request 402 can also include a starting URI 422 of {“uri”:“redfish/v1/Systems”} to which additional URI information for members (or actions, as described below in relation to FIGS. 5A and 5B) may be appended. Request 402 can also include a key-value pair or an option 426 of {“members”:true}, which can indicate that the members list is to be traversed to determine the data.id or URI for each expanded hostname. Request 402 can additionally include a key-value pair or an option 424 of {“keys”:“Model”}, where the key “keys” can indicate the filter “Model” for the response data. Both option 424 and option 426 can be customized options passed to and handled by the Redfish asynchronous API (228 of FIG. 2).

Request 402 can be parsed to perform the similar hostname expansion and member traversal (based on option 426) to generate the asynchronous HTTP requests, as described above for request 342. In addition, option 424 can indicate that the response data for request 402 can include only the information corresponding to the “Model” as defined for the URI or data.id of the given hostname. In diagram 400, each of sections 404, 406, 408, 410, and 412 indicates the hostname with the corresponding starting URI and data.id from the member traversal and further indicates that the “Model” information from the designated endpoint is returned. For example, as shown in section 408, “cnodeX12” corresponds to a data.id of “redfish/v1/Systems/Node1/Systems,” and request 402 can generate an asynchronous

HTTP request that returns the information of {“Model”:“BladeModelX12”} for “redfish/v1/Systems/Node1/Systems.” By using the hostname expansion along with the member traversal and the search key, the described embodiments can remain agnostic to the actual hardware types of the endpoints and return specific information. In this case, the single request 402 does not need to have knowledge of the hardware type or component “CrayNode1” (depicted in mapping 306 of FIG. 3A) as corresponding to “redfish/v1/System/Node1/Systems.” Instead, the system can use a single REST request to generate the desired asynchronous HTTP requests using the members and keys options passed to the Redfish asynchronous API. This can result in hardware-agnostic execution of asynchronous operations on REST endpoints.

FIG. 4B presents a diagram 430 depicting pseudocode for a single REST API request (including a search key and a traversal of the members) and the corresponding response data, in accordance with an aspect of the present application. Specific product names, paths, or information in diagram 430 are provided as non-limiting illustrative examples. Diagram 430 can include pseudocode for an exemplary REST API request 432. Similar to request 402 of diagram 400, request 432 can indicate a “GET” command (“-XGET”) to retrieve or obtain data. “admin:4445” can indicate the server providing the endpoint. A search term 450 of {“windom*, dl*”} can be used to search a database for a list of expanded hostnames, to obtain the associated credentials and the URI or data.id for each hostname. Request 432 can also include a starting URI 452 of {“uri”:“redfish/v1/Systems”}. Request 432 can include a key-value pair or an option 454 of {“members”:true}, which can indicate that the members list is to be traversed to determine the data.id or URI for each expanded hostname. Request 432 can additionally include a key-value pair or an option 456 of {“keys”:[“Name”, “Description”, “Manufacturer”, “Model”, “PartNumber”, “SerialNumber”]}, which can indicate the listed filters for the response data. Both option 454 and option 456 can be customizable options passed to and handled by the Redfish asynchronous API (228 of FIG. 2).

Request 432 can be parsed to perform the similar hostname expansion and member traversal (based on option 454) to generate the asynchronous HTTP requests, as described above for request 342. In addition, option 456 can indicate that the response data for request 432 can include only the information corresponding to the listed filters as defined for the URI or data.id of the given hostname. In diagram 430, section 434 indicates that for the hostname “windom0012,” two nodes exist, and the requested response data (including all the requested search key filters) can be depicted in section 436 for “Node1” of “windom0012” and in section 438 for “Node0” of “windom0012.” Section 440 indicates that for the hostname “dl365,” only one node exists, and the requested response data (including all the requested search key filters) can be depicted in section 442 for “1” of “dl365.”

For example, as shown in section 438, the requested response data for “Node0” of “windom0012” indicates the hostname with the corresponding starting URI and data.id from the member traversal and further indicates that the search key filter information is returned. Thus, request 432 can generate an asynchronous HTTP request that returns the following information for the URI “redfish/v1/Systems/Node0,” including: {“Name”: “Node0”, “Description”: “WNC”, “Manufacturer”: “HPE”, “Model”: “HPE CRAY EX425 (ROME)”, “PartNumber”: “101920703.D”, “SerialNumber”: “HA19320067”}.

The REST request can be further optimized to execute an action on multiple endpoints while remaining agnostic to the mapping of the actual hardware and URI. FIG. 5A presents a diagram 500 depicting pseudocode for a single REST API request (including a search key, a traversal of the members, and a target action) and the corresponding request data, in accordance with an aspect of the present application. Specific product names, paths, or information in diagram 500 are provided as non-limiting illustrative examples. Diagram 500 can include pseudocode for an exemplary REST API request 502, listed as a “curl” command for illustration purposes only. Request 502 can indicate a “POST” command (“-sxPOST”) to send data or a command. “admin:4445” can indicate the server providing the endpoint and a search term 520 of “c*” can be used to obtain expanded hostnames. Search term 520 can be used to search a database for a list of expanded hostnames to obtain the associated credentials and the URI or data.id for each hostname. Request 502 can include a starting URI 522 of {“uri”:“redfish/v1/Systems”} to which additional URI information for members or actions may be appended. Request 502 can include a key-value pair or an option 524 of {“members”:true}, which can indicate that the members list is to be traversed to determine the data.id or URI for each expanded hostname. Request 502 can further include a key-value pair or an option 526 of {“uri_action”:“/Actions/ComputerSystem. Reset”}, where the key “uri_action” can indicate the partial URI associated with a target action. In addition, request 502 can include an option 528 of {“json”:“{“ ResetType”:“On”}}, which can be a key indicating a JSON object with a parameter setting. Options 524, 526, and 528 can be customizable options passed to and handled by the Redfish asynchronous API (228 of FIG. 2).

Request 502 can be parsed to perform the similar hostname expansion and member traversal (based on option 524) to generate the asynchronous HTTP requests, as described above for request 342. In addition, option 526 can indicate that the partial URI is to be appended to the starting URI (522) after the hostname expansion, which can cause the target action indicated in option 526 to be executed using the parameter setting in the JSON object of option 528. In diagram 400, each of sections 506, 508, 510, 512, and 514 indicates the hostname with the corresponding starting URI and data. id from the member traversal and further indicates both the action URI and the JSON operation with the parameter setting.

For example, as shown in section 514, “cnodeY12Z” corresponds to a data.id of “redfish/v1/Systems/1234Serial78/Systems” (which can be obtained from a stored members list). Section 514 also indicates that the action URI corresponds to “redfish/v1/Systems/1234Serial78/Systems/Actions/ComputerSystem.Reset.” Section 514 further indicates that the generated asynchronous HTTP request is a POST command with the JSON parameter setting which is to reset the designated endpoint: {‘ResetType’:‘On’}.

By using the hostname expansion along with the member traversal, the search key, and the target action with the parameter setting, the described aspects can remain agnostic to the actual hardware types of the endpoints and can also perform specific actions on the endpoints using a single REST request. In this case, the single request 502 does not need to have knowledge of the hardware type or component “Intel” (depicted in mapping 310 of FIG. 3A) as corresponding to “redfish/v1/System/1234Serial78/Systems.” Instead, the system can use a single REST request (502) to generate the desired asynchronous HTTP requests using the members, keys, and action options passed to the Redfish asynchronous API. This can result in hardware-agnostic execution of asynchronous operations on REST endpoints.

FIG. 5B presents a diagram 530 depicting pseudocode for a single REST API request (including a search key, a traversal of the members, and a target action) and the corresponding response data, in accordance with an aspect of the present application. Specific product names, paths, or information in diagram 530 are provided as non-limiting illustrative examples. Diagram 530 can include pseudocode for an exemplary REST API request 532. Request 532 can indicate a “POST” command (“-sxPOST”) to send data or a command. “admin:4445” can indicate the server providing the endpoint. A search term 550 of {“windom003, dl*”} can be used to search a database for a list of expanded hostnames, to obtain the associated credentials and the URI or data.id for each hostname. Request 532 can also include a starting URI 552 of {“uri”:“redfish/v1/Systems”} to which additional URI information for members or actions may be appended. Request 532 can also include a key-value pair or an option 554 of {“members”:true}, which can indicate that the members list is to be traversed to determine the data.id or URI for each expanded hostname. Request 532 can include a key-value pair or an option 556 of {“uri_action”:“/Actions/ComputerSystem. Reset”}, where the key “uri_action” can indicate the partial URI associated with a target action. In addition, request 532 can include an option 558, which can be a key indicating a JSON object with a parameter setting. Options 554, 556, and 558 can be customizable options passed to and handled by the Redfish asynchronous API (228 of FIG. 2).

Request 532 can be parsed to perform the similar hostname expansion and member traversal (based on option 554) to generate the asynchronous HTTP requests, as described above for request 342. In addition, option 556 can indicate that the partial URI is to be appended to the starting URI (552) after the hostname expansion, which can cause the target action indicated in option 556 to be executed using the parameter setting in the JSON object of option 558. In diagram 530, section 534 indicates that for the hostname “windom003,” two nodes exist, and the data returned as a result of performing the target action can be depicted in section 536 for “Node0” of “windom003” and in section 538 for “Node1” of “windom0003.” Section 540 indicates that for the hostname “dl365,” only one node exists, and the data returned as a result of performing the target action can be depicted in section 542 for “1” of “dl365.”

For example, as shown in section 542, the returned data for “1” of “dl365” indicates the hostname with the corresponding URI (e.g., the action URI of diagram 500), which includes the starting URI and data. id from the member traversal appended with the action URI (556). Along with the URI, the returned data in section 542 also includes other information, such as {“Code”: 204, “Message”: “No Content”}. In some aspects, the user can request any contents that may be returned from a POST REST by setting an option of {“Message”: true}. If any contents are returned, the information may appear in the “Message” portion of, e.g., sections 536, 538, and 542.

Thus, request 532 can generate an asynchronous HTTP request that returns the information in sections 542 for the URI “redfish/v1/Systems/1/Actions/ComputerSystem. Reset” (and correspondingly, the information in sections 536 and 538 for, respectively, the URIs “redfish/v1/Systems/Node0/Actions/ComputerSystem.Reset” and “redfish/v1/Systems/Node1/Actions/ComputerSystem.Reset”).

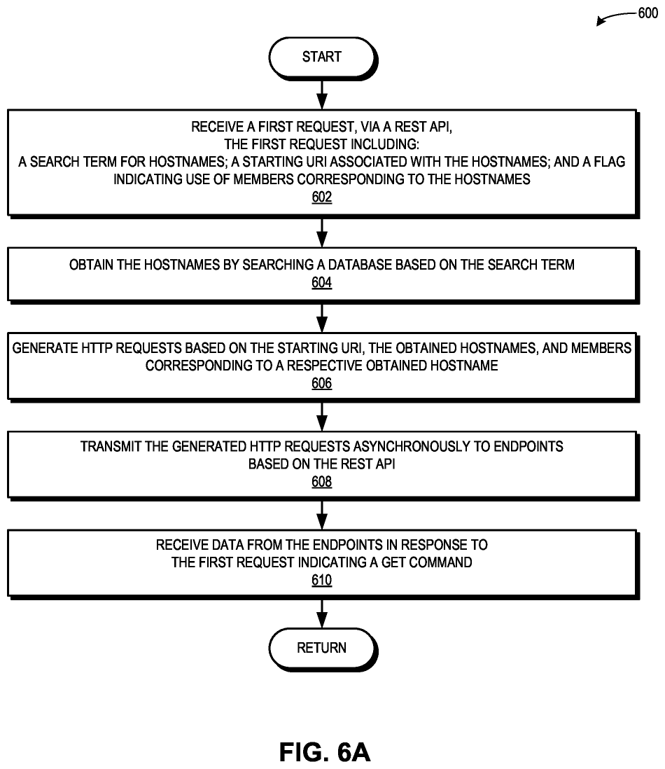

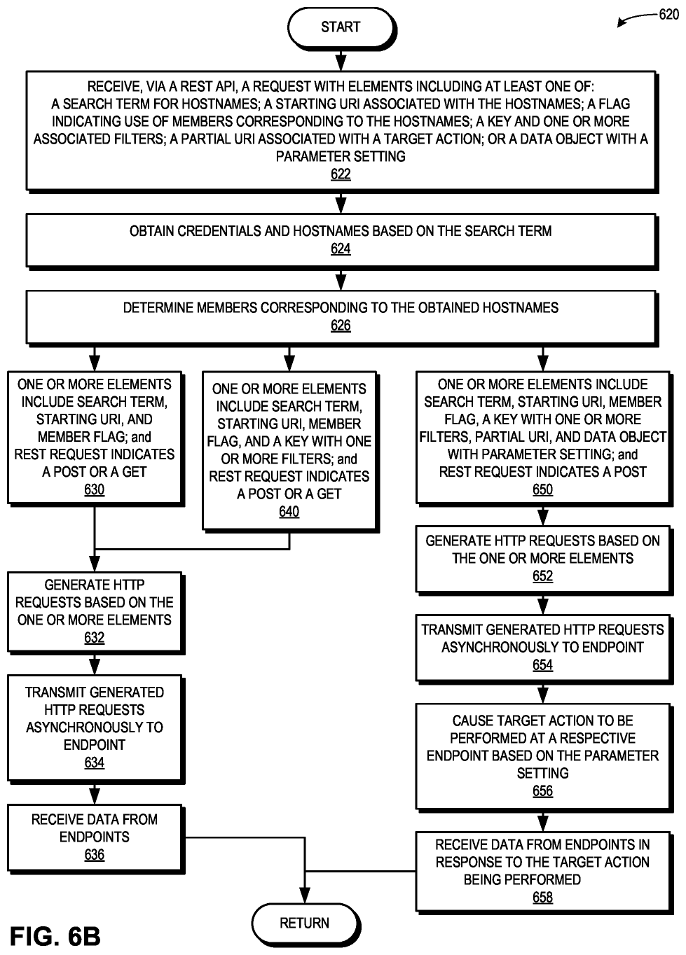

FIG. 6A presents a flowchart 600 illustrating a method which facilitates hardware-agnostic REST endpoints for asynchronous operations, in accordance with an aspect of the present application. During operation, a system receives a first request, via a REST API, the first request including: a search term for hostnames; a starting universal resource identifier (URI) associated with the hostnames; and a flag indicating use of members corresponding to the hostnames (“member flag”) (operation 602). The search term can be used to subsequently search in a database for expanded hostnames corresponding to the search term (as in operation 604), and the starting URI can be used to subsequently generate the multiple HTTP requests (as in operation 606). The member flag can be one of a plurality of customizable options that can be specified in the first request. For example, the “member” option (i.e., the member flag) is described above in relation to FIG. 3C.

Next, the system obtains the hostnames by searching a database based on the search term (operation 604), as described above in relation to section 344 of FIG. 3C and hostname expansion 230 of FIG. 2. The system generates HTTP requests based on the starting URI, the obtained hostnames, and members corresponding to a respective obtained hostname (operation 606) and transmits the generated HTTP requests asynchronously to endpoints based on the REST API (operation 608). The system receives data from the endpoints in response to the first request indicating a GET command (operation 610). For example, given REST API request 342 of FIG. 3C, the system can generate and transmit HTTP requests indicated in sections 344-354 which traverse the members list for the expanded hostnames and returns all the data from each individually generated HTTP request. The system can also receive data in response to the first request indicating a POST command, as described above in relation to FIGS. 5A and 5B. The operation returns.

FIG. 6B presents a flowchart 620 illustrating a method which facilitates hardware-agnostic REST endpoints for asynchronous operations, in accordance with an aspect of the present application. During operation, the system receives, via a REST API, a request with elements including at least one of: a search term for hostnames; a starting URI associated with the hostnames; a flag indicating use of members corresponding to the hostnames (“member flag”); a key and one or more associated filters; a partial URI associated with a target action; or a data object (e.g., a JSON object with a parameter setting (operation 622). The elements may correspond to options. For example, the “member” option (i.e., the member flag) is described above in relation to FIG. 3C, the “keys” option (i.e., the key and associated search filters) is described above in relation to FIGS. 4A and 4B, and the “action” option (i.e., the partial URI associated with a target action and the JSON body with the parameter setting) is described above in relation to FIGS. 5A and 5B.

The system obtains credentials and hostnames based on the search term (operation 624), as described above in relation to hostname expansion 230 of FIG. 2. The system determines members corresponding to the obtained hostnames (operation 626). For example, the system can use the “members” property of a Resource Collection, which can identify the members of the collection. The system can perform a lookup to find entries corresponding to the identified members, and the entries can include a list of URIs or data identifiers contained in the top level of the starting URI. The system can thus traverse the members list to determine the URI or data identifier for each expanded hostname, as described above in relation to FIGS. 3A, 3B, and 3C.

The system generate HTTP requests based on the one or more elements. For example, if the one or more elements include the search term, starting URI, and member flag, and the REST request indicates a POST or a GET command (operation 630), the system generates the HTTP requests based on those elements (operation 632), similar to REST API request 342 of FIG. 3C. If the REST API request is a GET command, the endpoints may return data as specified in the GET command. If the REST API request is a POST or other update-related command, the endpoints may return response data which may indicate “No Content” (as depicted in FIG. 5B) or any response data as requested if a key-value option in the REST API request is set as {“Message”:true}. The system transmits the generated HTTP requests asynchronously to the endpoints (operation 634). The system receives data from the endpoints (operation 634), where the received data depends on whether the command was a POST or a GET and also depends on what options were included in the REST request. The operation returns.

If the one or more elements include the search term, starting URI, member flag, and a key with one or more filters, and the REST request indicates a POST or a GET command (operation 640), the system generates the HTTP requests based on those elements (operation 642), similar to REST API requests 402 and 432 of FIGS. 4A and 4B. The operation continues at operations 632 and 634 (i.e., transmit the generated HTTP requests asynchronously to the endpoints and receive certain data from the endpoints) and the operation returns.

If the one or more elements include the search term, starting URI, member flag, a key with one or more filters, a partial URI associated with a target action, and a data object (e.g., a JSON object or body) with a parameter setting, and the REST request indicates a POST command (operation 650), the system generates the HTTP requested based on those elements (operation 652), similar to REST API requests 502 and 532 of FIGS. 5A and 5B. The system transmits the generated HTTP requests asynchronously to the endpoints (operation 654). The system causes the target action to be performed at a respective endpoint based on the parameter setting (operation 656). For example, if the partial URI and the parameter setting in the JSON object indicate to turn on or reset a particular endpoint (as in options 556 and 558 of FIG. 5B), transmitting the HTTP requests can cause the target action to be performed at the designated or identified endpoints (i.e., on the hardware component at the endpoint). The system receives data from the endpoints in response to the target action being performed (operation 658), such as the information in sections 534-542 of FIG. 5B. The operation returns.

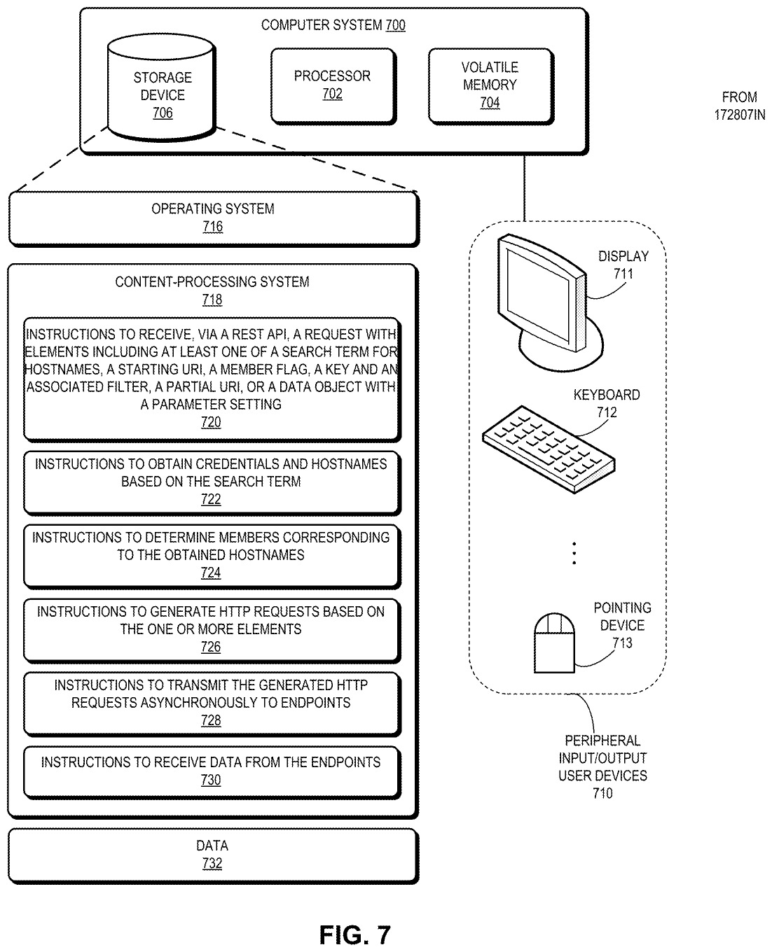

FIG. 7 illustrates a computer system 700 which facilitates hardware-agnostic REST endpoints for asynchronous operations, in accordance with an aspect of the present application. Computer system 700 includes a processor 702, a memory 704, and a storage device 706. Memory 704 can include a volatile memory (e.g., random access memory (RAM)) that serves as a managed memory and can be used to store one or more memory pools. Furthermore, computer system 700 can be coupled to peripheral I/O user devices 710 (e.g., a display device 711, a keyboard 712, and a pointing device 713). Storage device 706 includes non-transitory computer-readable storage medium and stores an operating system 716, a content-processing system 718, and data 732. Computer system 700 may include fewer or more entities or instructions than those shown in FIG. 7.

Content-processing system 718 can include instructions, which when executed by computer system 700, can cause computer system 700 to perform methods and/or processes described in this disclosure. Specifically, content-processing system 718 may include instructions 720 to receive, via a REST API, a request with elements including at least one of: a search term for hostnames; a starting universal resource identifier (URI) associated with the hostnames; a flag indicating use of members corresponding to the hostnames (“member flag”); a first key and one or more associated filters; a partial URI associated with a target action; or a second key indicating a data object (e.g., a JSON object) with a parameter setting. An example REST API request including the search term, starting URI, and member flag is described above in relation to FIG. 3C. An example REST API request including the search term, starting URI, member flag, and a key with an associated filter is described above in relation to FIGS. 4A and 4B. An example REST API including the search term, starting URI, member flag, a key with an associated filter, a target action, and a JSON object with a parameter setting is described above in relation to FIGS. 5A and 5B.

Content-processing system 718 may also include instructions 722 to obtain credentials and hostnames based on the search term, as described above in relation to hostname expansion 230 of FIG. 2. Content-processing system 718 may include instructions 724 to determine members corresponding to the obtained hostnames, as described above in relation to FIGS. 3A, 3B, and 3C.

Content-processing system 718 may include instructions 726 to generate HTTP requests based on the one or more elements. For example, when the REST API request includes the search term, starting URI, and member flag, the generated HTTP requests may be based on those elements, as described above in relation to REST API request 342 of FIG. 3C. When the REST API request includes the search term, starting URI, member flag, and a key with one or more filters, the generated HTTP requests may be based on those elements, as described above in relation to REST API requests 402 and 432 of FIGS. 4A and 4B. When the REST API request includes the search term, starting URI, member flag, a key with one or more filters, a partial URI associated with a target action, and a data object with a parameter setting, the generated HTTP requests may be based on those elements, as described above in relation to REST API requests 502 and 532 of FIGS. 5A and 5B.

Content-processing system 718 can include instructions 728 to transmit the generated HTTP requests asynchronously to endpoints, as described above in relation to asynchronous requests 160 of FIG. 1 and asynchronous HTTP requests 240 of FIG. 2. Content-processing system 718 can also include instructions 730 to receive data from the endpoints. For example, if the REST API request is a GET command, the endpoints may return data as specified in the GET command. If the REST API request is a POST or other update-related command, the endpoints may return response data which may indicate “No Content” (as depicted in FIG. 5B) or any response data as requested if a key-value option in the REST API request is set as {“Message”:true}.

Data 732 can include any data that is required as input or that is generated as output by the methods, operations, communications, and/or processes described in this disclosure. Specifically, data 732 can store at least: a request; a call; a command; a REST API request, call, or command; a parsed request; an option; a customizable option; a search term; one or more hostnames; a starting URI; a partial URI indicating a target action; an action; a target action; a data object or body; a JSON object; a parameter setting; a data object or body with a parameter setting; a JSON object with a parameter setting; an HTTP request; an asynchronous HTTP request; an identifier of an endpoint; a list of members; login or access credentials associated with a host, hostname, endpoint, or member; a member flag; a key-value pair; an option indicated by a key-value pair; a key and one or more associated filters; a status; response or return data; a first set of options; a type associated with an option; an option type; and an indicator of an underlying API or a Redish asynchronous API.

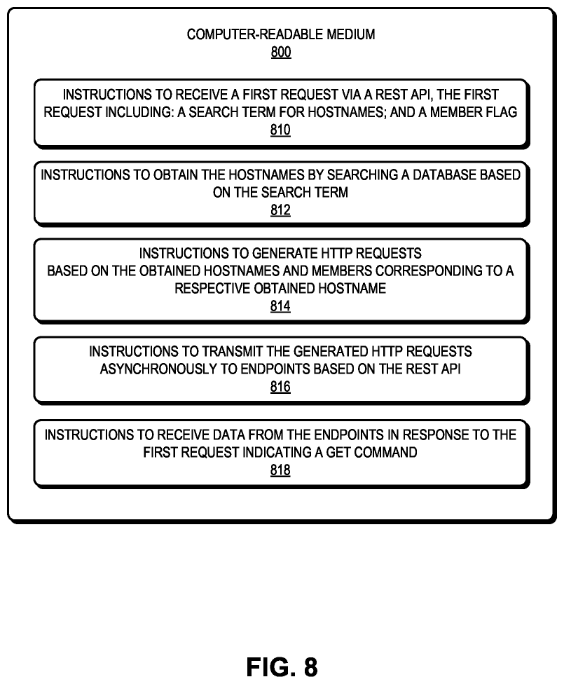

Computer system 700 and content-processing system 718 may include more instructions than those shown in FIG. 7. For example, content-processing system 718 can also store instructions for executing the operations described above in relation to: the environment of FIG. 1; the communications of FIG. 2; the generation of the asynchronous HTTP requests from a single REST request, as described in relation to FIGS. 3C, 4A, 4B, 5A, and 5B; the operations depicted in the flowcharts of FIGS. 6A-6B; and the instructions of non-transitory computer-readable medium 800 in FIG. 8.

FIG. 8 illustrates a computer-readable medium (CRM) 800 which facilitates hardware-agnostic REST endpoints for asynchronous operations, in accordance with an aspect of the present application. CRM 800 can be a non-transitory computer-readable medium or device storing instructions that when executed by a computer or processor cause the computer or processor to perform a method. CRM 800 can store instructions 810 to receive a first request via a REST API, the first request including: a search term for hostnames; and a flag indicating use of members corresponding to the hostnames (“member flag”), as described above in relation to the REST API requests of FIGS. 3C, 4A, 4B, 5A, and 5B.

CRM 800 can also include instructions 812 obtain the hostnames by searching a database based on the search term, as described above in relation to hostname expansion 230 of FIG. 2. CRM 800 can include instructions 814 to generate HTTP requests based on the obtained hostnames and members corresponding to a respective obtained hostname, as described above in relation to the REST API request of, e.g., FIG. 3C.

CRM 800 can additionally include instructions 816 to transmit the generated HTTP requests asynchronously to endpoints based on the REST API, as described above in relation to asynchronous requests 160 of FIG. 1 and asynchronous HTTP requests 240 of FIG. 2. CRM 800 can include instructions 818 to receive data from the endpoints in response to the first request indicating a GET command, as described above in relation to REST API requests 402 and 432 of FIGS. 4A and 4B.

CRM 800 may include more instructions than those shown in FIG. 8. For example, CRM 800 can also store instructions for executing the operations described above in relation to: the environment of FIG. 1; the communications of FIG. 2; the generation of the asynchronous HTTP requests from a single REST request, as described in relation to FIGS. 3C, 4A, 4B, 5A, and 5B; the operations depicted in the flowcharts of FIGS. 6A-6B; and the instructions of computer system 700 in FIG. 7.

The described aspects provide a specific implementation and technological solution (e.g., facilitating hardware-agnostic REST endpoints for asynchronous operations) by providing a single, configurable access point (e.g., a REST API request) which can include hostname expansion with access credentials, pre-existing options for underlying Python APIs, and customizable options (e.g., members, keys, and actions) for Redfish asynchronous APIs. The described solution generates, based on the single REST API request, multiple HTTP requests which can be asynchronously sent to the endpoints. The described aspects provide a solution to a technological problem in the computer arts (e.g., using the REST API without needing prior knowledge of the identifier of each specific hardware component for various vendors, resulting in hardware-agnostic REST endpoints). The described aspects further integrate into a practical application because they are necessarily rooted in computer technology (e.g., increasing the efficiency of communication and transfer of data using the REST API over HTTP and eliminating the need to specifically identify the hardware directly from individual and original REST requests).

In general, the disclosed aspects provide a method, a computer system, and a computer-readable medium for facilitating a hardware-agnostic REST endpoint for asynchronous operations. During operation, the system receives a first request, via a Representational State Transfer (REST) application programming interface (API). The first request includes: a search term for hostnames; a starting universal resource identifier (URI) associated with the hostnames; and a flag indicating use of members corresponding to the hostnames. The system obtains the hostnames by searching a database based on the search term. The system generates HTTP requests based on the starting URI, the obtained hostnames, and members corresponding to a respective obtained hostname. The system transmits the generated HTTP requests asynchronously to endpoints based on the REST API. The system receives data from the endpoints in response to the first request indicating a GET command.

In a variation on this aspect, the first request further includes a first key associated with a first filter. The system generates the HTTP requests based further on the first key and the first filter. In response to transmitting the generated http requests asynchronously to the endpoints, the system receives, from a respective endpoint, a value corresponding to the first filter.

In a further variation, the first request indicates a POST command, and the first request further includes: a partial URI associated with a target action; and a second key indicating a data object (such as a JavaScript Object Notation (JSON) object) with a parameter setting.

In a further variation, the system generates the HTTP requests based further on: the partial URI associated with the target action; and the second key indicating the data object (e.g., the JSON object) with the parameter setting. In response to transmitting the generated http requests asynchronously to the endpoints, the system causes the target action to be performed at a respective endpoint based on the parameter setting.

In a further variation, the system receives, from the respective endpoint, a status associated with the target action which is performed at the respective endpoint based on the parameter setting.

In a further variation, the first request further includes a flag requesting a return of content in response to the target action being performed, and the received status indicates the returned content.

In a further variation, the system determines options associated with the first request by parsing the first request based on a format associated with the data object (e.g., JSON if the data object is formatted as a JSON object). The system passes the first request to an underlying API in response to the options comprising a first set of options. The system passes the first request to an asynchronous API in response to the options comprising a second set of options, wherein the asynchronous API is associated with a protocol for management of components in a software-defined hybrid network environment.

In a further variation, the underlying API includes at least one of: a ClientRequest class; a ClientSession class; or a TCPConnector class.

In a further variation, obtaining the hostnames is based further on matching credential information associated with the first request with credential information associated with a respective expanded hostname.

In another aspect, a computer system comprises a processor and a storage device storing instructions. The instructions are to receive a request via a representational state transfer (REST) application programming interface (API), the request with elements including at least one of: a search term for hostnames; a starting universal resource identifier (URI) associated with the hostnames; a flag indicating use of members corresponding to the hostnames; a first key associated with one or more filters; a partial URI associated with a target action; or a second key indicating a data object (e.g., a JavaScript Object Notation (JSON) object) with a parameter setting. The instructions are further to obtain the hostnames and corresponding credentials by searching a database based on the search term. The instructions are further to determine members corresponding to the obtained hostnames and generate Hypertext Transfer Protocol (HTTP) requests based on the one or more elements. The instructions are further to transmit the generated HTTP requests asynchronously to endpoints based on the REST API and, responsive to the request indicating a GET command, receive data from the endpoints. The computer system may include a content-processing system which includes the instructions to perform the operations described herein, including in relation to: the environment of FIG. 1; the communications of FIG. 2; the generation of the asynchronous HTTP requests from a single REST request, as described in relation to FIGS. 3C, 4A, 4B, 5A, and 5B; the operations depicted in the flowcharts of FIGS. 6A-6B; the instructions of computer system 700 of FIG. 7; and the instructions of non-transitory computer-readable medium 800 in FIG. 8.

In another aspect, a non-transitory computer-readable storage medium (or CRM) stores instructions to receive a first request, via a representational state transfer (REST) application programming interface (API), the first request including: a search term for hostnames; and a flag indicating use of members corresponding to the hostnames. The instructions are further to obtain the hostnames by searching a database based on the search term and generate Hypertext Transfer Protocol (HTTP) requests based on the obtained hostnames and members corresponding to a respective obtained hostname. The instructions are further to transmit the generated HTTP requests asynchronously to endpoints based on the REST API and receive data from the endpoints in response to the first request indicating a GET command. The CRM can also store instructions for executing the operations described above in relation to: the environment of FIG. 1; the communications of FIG. 2; the generation of the asynchronous HTTP requests from a single REST request, as described in relation to FIGS. 3C, 4A, 4B, 5A, and 5B; the operations depicted in the flowcharts of FIGS. 6A-6B; the instructions of computer system 700 in FIG. 7; and the instructions of non-transitory computer-readable medium 800 in FIG. 8.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method, comprising:
receiving a first request, via a representational state transfer (REST) application programming interface (API), the first request including:
a search term for hostnames;
a starting universal resource identifier (URI) associated with the hostnames; and
a flag indicating use of members corresponding to the hostnames;
obtaining the hostnames by searching a database based on the search term;
generating Hypertext Transfer Protocol (HTTP) requests based on the starting URI, the obtained hostnames, and members corresponding to a respective obtained hostname;
transmitting the generated HTTP requests asynchronously to endpoints based on the REST API; and
receiving data from the endpoints in response to the first request indicating a GET command.

2. The method of claim 1,
wherein the first request further includes a first key associated with a first filter, and
wherein the method further comprises:
generating the HTTP requests based further on the first key and the first filter; and
in response to transmitting the generated http requests asynchronously to the endpoints, receiving, from a respective endpoint, a value corresponding to the first filter.

3. The method of claim 1,
wherein the first request indicates a POST command, and
wherein the first request further includes:
a partial URI associated with a target action; and
a second key indicating a data object with a parameter setting.

4. The method of claim 3, further comprising:
generating the HTTP requests based further on:
the partial URI associated with the target action; and
the second key indicating the data object with the parameter setting; and
in response to transmitting the generated http requests asynchronously to the endpoints, causing the target action to be performed at a respective endpoint based on the parameter setting.

5. The method of claim 4, further comprising:
receiving, from the respective endpoint, a status associated with the target action which is performed at the respective endpoint based on the parameter setting.

6. The method of claim 5,
wherein the first request further includes a flag requesting a return of content in response to the target action being performed, and
wherein the received status indicates the returned content.

7. The method of claim 1, further comprising:
determining options associated with the first request by parsing the first request based on a format associated with the data object;
passing the first request to an underlying API in response to the options comprising a first set of options; and
passing the first request to an asynchronous API in response to the options comprising a second set of options, wherein the asynchronous API is associated with a protocol for management of components in a software-defined hybrid network 8 environment.

8. The method of claim 7, wherein the underlying API includes at least one of:
a ClientRequest class;
a ClientSession class; or
a TCPConnector class.

9. The method of claim 1,
wherein obtaining the hostnames is based further on matching credential information associated with the first request with credential information associated with a respective expanded hostname.

10. A computer system, comprising:
a processor; and
a storage device storing instructions to:
receive a request via a representational state transfer (REST) application programming interface (API), the request with elements including at least one of:
a search term for hostnames;
a starting universal resource identifier (URI) associated with the hostnames;
a flag indicating use of members corresponding to the hostnames;
a first key associated with one or more filters;
a partial URI associated with a target action; or
a second key indicating a data object with a parameter setting;
obtain the hostnames and corresponding credentials by searching a database based on the search term;
determine members corresponding to the obtained hostnames;
generate Hypertext Transfer Protocol (HTTP) requests based on the one or more elements;
transmit the generated HTTP requests asynchronously to endpoints based on the REST API; and
receive data from the endpoints in response to the request indicating a GET or a POST command.

11. The computer system of claim 10,
the instructions further to, in response to the elements including the first key associated with the one or more filters:
generate the HTTP requests based further on the first key and the one or more filters; and
in response to transmitting the generated http requests asynchronously to a respective endpoint, receive one or more values corresponding to the one or more filters.

12. The computer system of claim 10,
the instructions further to, in response to the request indicating a POST command and the elements including the partial URI and the second key:
generate the HTTP requests based further on the partial URI and the second key; and
in response to transmitting the generated http requests asynchronously to a respective endpoint, cause the target action to be performed at the respective endpoint based on the parameter setting.

13. The computer system of claim 12, the instructions further to:
receive, from the respective endpoint, a status associated with the target action performed at the respective endpoint.

14. The computer system of claim 10, the instructions further to:
determine options associated with the request by parsing the request based on a format associated with the data object;
pass the request to an underlying API in response to the options comprising a first type; and
pass the request to an asynchronous API in response to the options comprising a second type, wherein the asynchronous API is associated with a protocol for management of components in a software-defined hybrid network environment.

15. The computer system of claim 10, the instructions further to:
obtain the hostnames by matching credential information associated with the request with credential information associated with a respective obtained hostname.

16. A non-transitory computer-readable medium storing instructions to:
receive a first request, via a representational state transfer (REST) application programming interface (API), the first request including:
a search term for hostnames; and
a flag indicating use of members corresponding to the hostnames;
obtain the hostnames by searching a database based on the search term;
generate Hypertext Transfer Protocol (HTTP) requests based on the obtained hostnames and members corresponding to a respective obtained hostname;
transmit the generated HTTP requests asynchronously to endpoints based on the REST API; and
receive data from the endpoints in response to the first request indicating a GET command.

17. The non-transitory computer-readable medium of claim 16,
wherein the first request includes a starting universal resource identifier (URI) associated with the hostnames, and
wherein the instructions are further to generate the HTTP requests based further on the starting URI.

18. The non-transitory computer-readable medium of claim 16,
wherein the first request includes a first key associated with a first filter, and
wherein the instructions are further to:
generate the HTTP requests based further on the first key and the first filter; and
in response to transmitting the generated http requests asynchronously to the endpoints, receive, from a respective endpoint, a value corresponding to the first filter.

19. The non-transitory computer-readable medium of claim 16,
wherein the first request indicates a POST command and further includes:
a partial URI associated with a target action; and
a second key indicating a data object with a parameter setting, and wherein the instructions are further to:
generate the HTTP requests based further on the partial URI and the second key; and
responsive to transmitting the generated http requests asynchronously to the endpoints, cause the target action to be performed at a respective endpoint based on the parameter setting.

20. The non-transitory computer-readable medium of claim 16, wherein the instructions are further to:
determine options associated with the first request by parsing the first request based on a format associated with the data object;
pass the first request to an underlying API in response to the options comprising a first set of options;
pass the first request to an asynchronous API in response to the options comprising a second set of options, wherein the asynchronous API is associated with a protocol for management of components in a software-defined hybrid network environment; and
receive data in the format from the endpoints in response to the first request.
